(19) United States
(12) Patent Application Publication
(10) Pub. No.: US 2012/0064198 A1
(43) Pub. Date: Mar. 15, 2012

(54) LABELS FOR PRODUCE

(75) Inventors: Craig M. Kehres, Wadsworth, OH (US); Pamela A. Percha, Woodbury, MN (US); Daniel P. Sheehy, Austin, TX (US); Eric L. Zilley, St. Paul, MN (US)

(73) Assignee: 3M Innovative Properties Company

(21) Appl. No.: 12/882,520

(22) Filed: Sep. 15, 2010

(51) Int. Cl. G09F 3/10; B32B 38/10; B65D 85/34; B32B 27/08; B32B 7/12; B29C 65/02; B65C 3/00

(52) U.S. Cl. 426/87; 156/320; 156/247

(57) ABSTRACT

Described herein is a label for produce wherein the label comprises a facestock and a heat-activated adhesive having a viscosity at 100° C. of less than 4.5×10⁶ Poise as measured according to the Viscosity Test Procedure, and wherein the heat-activated adhesive bonds the label to a surface of the piece of produce.

### TECHNICAL FIELD

A label for produce is described. The label comprises a heat-activated adhesive and when applied to produce, shows sufficient adhesion.

### BACKGROUND

Food products are labeled to provide information related to, among other things, country of origin, the source, lot number, price look-up (or PLU), etc. This information is also helpful during a recall to sort out, for example, where the food came from and which batch of food products were impacted. The U.S. Farm Security and Rural Investment Act of 2002 required retailers to identify country of origin on meats, peanuts, and produce. For packaged items this product information is easily applied onto the package. However, the labeling of non-packaged items such as produce is not trivial.

Pressure sensitive adhesives have been used for many years in the food industry because of their ability to be easily applied to produce and not damage it. Because of the high throughput needed, food manufacturers continue to use pressure sensitive adhesives to label produce.

Generally, when using conventional pressure sensitive adhesive labels, the labels do not readily adhere to wet or irregularly-surfaced fruits and vegetables. Thus, these labels detach from the produce before reaching the customer, making it difficult to track a piece of produce back to the source if needed.

A label that is easily applied and which readily adheres to the surface of the produce has been desired. For example, U.S. Pat. No. 4,547,001, describes the problem of labeling irregular and curved-surface produce and identifies a pressure sensitive label with conforming lobes that was said to help with adhesion to non-planar fruits and vegetables.

### SUMMARY

There is a desire to find a label for produce, especially when the produce is wet or has an irregular surface, that is not easily removed. There is also a desire for the label to be used in high-throughput settings, while not damaging the fruit.

In one aspect, an article is described comprising a piece of produce and a label, wherein the label comprises a heat-activated adhesive, wherein the heat-activated adhesive has a viscosity at 100° C. of less than 4.5×10⁶ Poise as measured according to the Viscosity Test Procedure, and wherein the heat-activated adhesive bonds the label to a surface of the piece of produce.

In another aspect, a method of labeling produce is described comprising: providing a label comprising a heat-activated adhesive and heating the adhesive to attach the label to a surface of a piece of produce, wherein the heat-activated adhesive has a viscosity at 100° C. of less than 4.5×10⁶ Poise when measured according to the Viscosity Test Procedure.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

FIG. 1 is a schematic side-view of a label according to the present disclosure

FIG. 2 is a schematic side-view of a label according to the present disclosure fixedly attached to the surface of a piece of produce.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed to labels that advantageously provide adequate adhesion to produce, especially difficult-to-label produce.

Produce, as used herein, refers to fruits and vegetables. Although the label of the present disclosure may be applied to any produce, the labels may be particularly well suited for produce having fibrous, pitted, and/or irregular surfaces. Exemplary produce having fibrous surfaces include, melons, such as cantaloupes, muskmelons and honeydews, coconuts, and kiwis. In some embodiments, these fibrous surfaces may be netted such as in the case of melons. Exemplary produce having pitted surfaces include, citrus fruit, such as oranges, lemons, and limes. Exemplary produce having irregular or uneven surfaces include, pineapples, avocados, and cucumbers.

The labels of the present disclosure may also be well suited for wet surfaces. Prior to labeling, manufacturers may wash the produce to remove soil or other debris (e.g., leaves) from the surface. In some instances, the produce may be exposed to cooling baths to chill the produce prior to labeling. Thus, in one embodiment, labeling of the produce may occur while the produce is still wet and the label will be applied to a wet or damp surface.

The present disclosure is directed to a label for produce comprising a heat-activated adhesive. As used herein heat-activated adhesives are those adhesives applied from the melt and gains strength upon solidification and crystallization. These heat-activated adhesives are applied without solvents. Heat-activated adhesives differ from pressure sensitive adhesives in that pressure sensitive adhesives are permanently tacky at room temperature and do not require activation by water, solvent, or heat in order to exert a strong adhesive holding force. A hot-melt pressure sensitive adhesive is a pressure sensitive adhesive that can be processed and/or coated at elevated temperatures, e.g., extrusion, and, depending on the formulation, may be optionally crosslinked afterwards. As mentioned in the background, produce that is wet or has an irregular surface can be challenging to label. Although a traditional label having a pressure sensitive adhesive may initially stick, it may have a tendency to fall off of the product during handling (shipping, etc.).

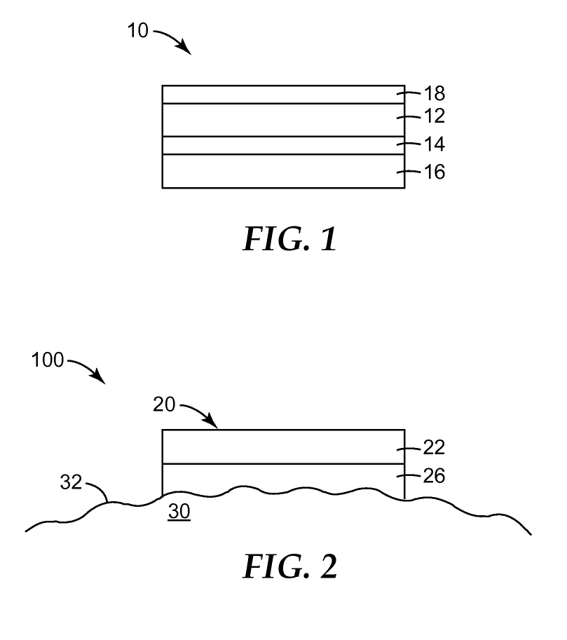

FIG. 1 depicts one exemplary embodiment of the label according to the present disclosure. Label 10 comprises facestock 12 and heat-activated adhesive layer 16, which is fixedly attached to facestock 12 via optional intermediate layer 14. Optional intermediate layer 14 is in contact with both facestock 12 and heat-activated adhesive layer 16. Optional top coat layer 18 is in contact with facestock 12 opposite the heat-activated adhesive layer.

The heat-activated adhesives of the present disclosure include an adhesive polymer and, optionally, additional additives. Adhesive polymers suitable for use in the heat-activated adhesives include those known in the art, including for example, polyesters, polyurethanes, ethylene-vinyl acetate copolymers, polyamides, polyolefins (e.g., low density polyethylene or polypropylene), styrene-butadiene block copolymers, styrene-isoprene block copolymers, and combinations thereof.

Various other materials may be incorporated into the heat-activated adhesive so long as they do not result in unacceptable bonding characteristics, such as too low a melt temperature or too high a bonding temperature. For example, tackifiers or liquid rubber may be used to modify the adhesion level, quick stick level, and/or viscosity. Additionally, waxes, fillers, pigment, plasticizers, antioxidants, UV stabilizers, photo crosslinkers, and so forth may be also employed.

Tackifiers useful in the heat-activated adhesives are typically low molecular weight materials and are usually compatible with the adhesive polymer, by which it is meant that there is no visible evidence of phase separation of these components at room temperature. Examples of commercially available tackifiers include those available under the trade designations “WINGTACK 95” and “WINGTACK 115” (from Goodyear Tire and Rubber Co.); “REGALREX 1078”, “REGALREX 1094”, and “REGALREX 1126” (from Hercules Chemical Co. Inc.); “AKRON P115” (from Arakawa Forest Chemical Industries); “ESCOREZ” (from Exxon Chemical Co.); and “FORAL 85” and “FORAL 105” (from Hercules Chemical Co., Inc.).

The heat-activated adhesive should be selected such that the adhesive has a low enough softening temperature so that the application temperature does not adversely affect the product. In other words, application of the label comprising the heat-activated adhesive should not damage (e.g., cook) or otherwise degrade the produce. In one embodiment, the heat-activated adhesive is selected such that it comprises groups that may interact with the surface of the produce through a molecular level interaction such as Van der Waals forces or hydrogen bonding.

In one embodiment, the heat-activated adhesives as disclosed herein are those that have a viscosity at 100° C. of less than 4.5×10⁶ Poise, 3.0×10⁶ Poise, 2.0×10⁶ Poise, 1.5×10⁶ Poise, 1.0×10⁶ Poise, or even 0.5×10⁶ Poise. In some embodiments, the heat-activated adhesives exhibit a noticeable viscosity drop at about 40° C. (104° F.) or higher, or even about 50° C. (122° F.) or higher.

In one embodiment, the heat-activated adhesives as disclosed herein have a glass transition temperature (i.e., Tg) of no more than −25° C., −28° C., or even −30° C.

A typical thickness range of the heat-activated adhesive layer is at least 15, 20, 25, or even 50 μm (micrometer); and no more than 100, 150, 200 or even 250 μm.

The heat-activated adhesive layer is attached to a facestock to form a label. In one embodiment, the heat-activated adhesive layer is in direct contact with the facestock. The heat-activated adhesive layer may be fully contacting the facestock or may be partially contacting the facestock. In another embodiment, the heat-activated adhesive layer is attached to the facestock via at least one intermediate layer. The intermediate layer may be fully or partially contacting the heat-activated adhesive layer and may be fully or partially contacting the facestock.

Facestocks useful in the present disclosure include those commonly known in the art and include, for example, papers, plastic films, metallized papers, metallized films, foils, synthetic fabrics, wovens, non-wovens, and synthetic papers, such as those available under the trade designation “TYVEK 122” by DuPont, Wilmington, Del. Useful examples for papers include uncoated paper such as micro-fiber uncoated paper, coated paper such as paper with an ink receptive coating, fiber board, cardstock and the like. Coated paper may be cast coated, gloss coated, and matte coated. Useful examples for films include polyvinyl chloride (vinyl film), polyester, polypropylene, polyethylene, polystyrene, acetate, and multilayer films. Facestock choices may also depend on the choice of printers.

Optional intermediate layer 14 as depicted in FIG. 1 may comprise for example, a layer to assist in the attachment of the heat-activated adhesive to the facestock. Such an optional layer may include, a primer layer or a pressure sensitive adhesive (PSA) layer, or combinations thereof. In one embodiment, more than one intermediate layer may be used in the label construction.

A primer layer may be applied between the facestock and heat-activated adhesive to enhance the anchorage of the heat-activated adhesive onto the facestock. Chemical priming may be used. Physical priming, especially for film facestock or film coated paper facestock, including Corona, flame, ozone, and plasma treatment may be used.

A pressure sensitive adhesive may be used to enhance the anchorage of the heat-activated adhesive onto the facestock or to a primer layer applied to the facestock. The pressure sensitive adhesive is not particularly limited and includes those known in the art. However, if a pressure sensitive adhesive is used, it should be compatible with the processing conditions of the label. A typical thickness of the pressure sensitive adhesive layer is between 10 and 200 μm.

A barrier coating may also be needed, especially when a paper facestock is used. Typical barrier coatings are thin polymer coatings, including polyethylene, polypropylene, and polyethylene terephthalate. It is found that a barrier coating makes a rough facestock smoother, which in turn enhances adhesion of the adhesive on desired surfaces.

In one embodiment, optional top coating layer 16 may be applied to the surface of the facestock, opposite the heat-activated adhesive layer. This top coat layer may be a print receptor treatment or may be a layer used to assist printing of the label or durability of the label, for example, water-proofing a paper facestock.

In the present disclosure, the label is applied to the produce with the heat-activated adhesive in contact with the surface of the produce. FIG. 2 depicts one embodiment of the present disclosure, wherein article 100 comprises label 20 and produce 30. Label 20, which comprises facestock 22 and heat-activated adhesive 26 is fixedly attached to surface 32 of produce 30.

Although not wanting to be bound by theory, it is believed that the labels of the present disclosure use mechanical attachment to form a reliable bond while thermoforming the label to the contour of the surface. It is believed that the heat-activated adhesives perform better on difficult-to-label produce surfaces, such as those which are netted or pitted, because upon application, the adhesive is softened, allowing the adhesive to flow within the crevices of the produce, resulting in a higher surface area contacted and thus improved adhesion of the label.

In one embodiment, the heat-activated adhesive of the present disclosure does not penetrate the surface of the produce, such that the label may be removed without compromising the produce's surface. In other words, when the label according to the present disclosure is applied to a fibrous surface and then removed, some fibers from the produce surface may be transferred to the removed label. However, the surface of the produce remains uncompromised with no flesh exposed.

The labels of the present disclosure may be applied to produce by exposing the label, with the heat-activated adhesive side contacting the produce, to a sufficient temperature such that the heat-activated adhesive melts or becomes flowable. Such exposure may involve an iron, a heated platen, a molded rubber head, and/or a hot stamp die, which may be done with manual or automated equipment. However, it is important that the exposure to the heat is sufficient to bond the label to the produce, yet not adversely affect the produce.

In one embodiment, the effectiveness of the bonding of the label comprising a heat-activated adhesive may be tested by applying the label to a melon (e.g., cantaloupe) and then removing the label. For adequate bonding, there should be a visible transfer of fibers from the surface of the cantaloupe to the heat-activated adhesive layer. If at least 1, 2, 5, 20, or even 50 fibers from the melon remain on a 25 mm×25 mm area of the heat-activated adhesive layer, then the heat-activated adhesive is sufficient to label the produce.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

These abbreviations are used in the following examples: g=gram, HAA=heat activated adhesive, Hz=Hertz, lb=pound, kg=kilograms, min=minutes, mol=mole; cm=centimeter, mm=millimeter, ml=milliliter, L=liter, PSA=pressure sensitive adhesive, psi=pressure per square inch, MPa=megaPascals, and wt=weight.

### Materials

| | |
|---|---|
| HAA 1 | A polyolefin adhesive film comprising a heat activated |
| | adhesive, available under the trade designation |
| | “INTEGRAL 801”, having a thickness of 0.001 inches |
| | (0.025 mm) and believed to be an ethylene/vinyl acetate |
| | type copolymer, available from Dow Chemical Co., |
| | Midland, MI. |
| HAA 2 | A polyolefin adhesive film comprising a heat activated |
| | adhesive available under the trade designation |
| | “INTEGRAL E100”, having a thickness of 0.001 inches |
| | (0.025 mm) and believed to be a polyethylene-based |
| | copolymer, available from Dow Chemical Co. |
| HAA 3 | A polyurethane thermoplastic adhesive film on a release |
| | paper available as “3218”, having a thickness of 0.003 |
| | inches (0.076 mm), available from BEMIS, Shirley, MA. |
| HAA 4 | A polyamide thermoplastic adhesive film on release |
| | paper available as “4220”, having a thickness of 0.003 |
| | inches (0.076 mm), available from BEMIS. |
| HAA 5 | A polyester thermoplastic adhesive film on release paper, |
| | available as “5250”, having a thickness of 0.003 inches |
| | (0.076 mm), available from BEMIS. |
| HAA 6 | A thermoplastic polyester (non-curing) film on a release |
| | coated paper liner, available under the trade designation |
| | “3M BONDING FILM 615”, having a thickness of |
| | 0.0025 inches (0.063 mm), available from 3M Co., St. |
| | Paul, MN. |
| HAA 7 | An unsupported ethylene/acrylic acid copolymer |
| | thermoplastic film, available under the trade designation |
| | “3M BONDING FILM 406”, having a thickness of 0.003 |
| | inches (0.08 mm), available from 3M Co. |
| PSA 1 | A solvent free, rubber-based pressure sensitive adhesive |
| | emulsion, having a solids level of approximately 54% by |
| | weight, obtained from 3M Co. |
| PSA 2 | A double linered pressure sensitive adhesive available |
| | under the trade designation “3M PERMANENT |
| | TACKIFIED ACRYLIC ADHESIVE P1410”, having a |
| | thickness of 0.0009 inches (0.023 mm), available from |
| | 3M Co. |
| PSA 3 | An aqueous emulsion of the pressure sensitive adhesive |
| | used in “3M HIGH PERFORMANCE PERMANENT |
| | TACKIFIED ACRYLIC ADHESIVE P1480”, an |
| | acrylate-based pressure sensitive adhesive, having a |
| | solids content of approximately 60% by weight, obtained |
| | from 3M Co. |
| PSA 4 | A pressure sensitive adhesive containing label |
| | construction having 0.002 inch (0.051 mm) thick matte |
| | white polyester facestock, a 0.0008 inch (0.02 mm) thick |
| | acrylic adhesive, and paper liner, available as MC |
| | Polyester Label Product FM 01961K, from 3M Co. |
| Label A | A pressure sensitive adhesive label, believed to have a |
| | rubber-based adhesive, removed from a cantaloupe |
| | melon purchased in a store. |
| Label B | An extruded film comprising a copolyester resin |
| | available as FP-759 Thermal Transfer Film, having a |
| | thickness of 0.005 inches (0.13 mm), available from |
| | Worthen Coated Fabrics, Grand Rapids, MI. |
| Label | a label construction of 60 lb. (27.2 kg) litho facestock |
| Facestock | laminated to a dull silver foil, having a nominal |
| | thickness of 0.0035 inches (0.089 mm), obtained from |
| | 3M Co. |

### Test Methods

Melon Bonding—Dry Melon

Labels of each construction, measuring approximately 1 by 1.5 inches (2.5 by 3.8 cm), were applied to a cantaloupe melon using a preheated clothing iron at its highest dry setting. The labels were placed on the melon with the adhesive side in contact with the melon, and a hot iron was rubbed over the label for a period of approximately 2 to 5 seconds, unless otherwise noted. The surface temperature of the hot iron was determined to be in the range of approximately 222 to 276° F. (106 to 136° C.) as measured with a non-contact pyrometer. The iron was then removed and the label was immediately evaluated for bond strength by peeling the label off the melon by hand and observing the extent to which any fiber pullout from the surface of the melon occurred. A rating of 1 to 10 was assigned, with 1 representing little or no bond strength and 10 representing a very high bond strength. In the fiber pullout evaluation, “none” indicates no visible fibers observed, “minimal” indicates at least a few fibers were visible, and “some” is more than minimal and indicates that a notable number of fibers were visible on the adhesive without having to examine the label closely.

Melon Bonding—Wet Melon

The Melon Bonding—Dry Melon test method as described above was repeated, except that the cantaloupe melon was thoroughly washed in a sink and then dabbed dry with a towel, leaving the surface very damp. The label was then contacted with the very damp surface of the melon, heated, and evaluated for bond strength in the manner described above.

Viscosity Test Procedure

The dynamic shear viscosity of adhesive samples was measured as a function of temperature from approximately 30 to 160° C. using a rheological dynamic analyzer (RDA-2, TA Instruments, New Castle, Del.) in a parallel plate configuration with 25 millimeter diameter plates, a gap setting of 1.5 mm, a starting strain of 1%, with autotension and autostrain on, a frequency of 1 Hz, and a temperature sweep rate of 5° C./minute. The viscosity values at 80° C., 100° C., 110° C., and 120° C. were reported.

Glass Transition Temperature (Tg) Test Procedure

Adhesive samples were scanned from approximately −65 to 80° C. (with the exception of HAA 1 (−65 to 15° C.) and HAA 3 (−65 to 45° C.)) using a dynamic mechanical analyzer (RSA-2, TA Instruments, New Castle, Del.) at a starting strain of 1%, with autotension and autostrain on, a frequency of 1 Hz, and a temperature sweep rate of 5° C./minute. The Tg was reported as the extrapolated onset of the storage modulus (E′) drop from the glassy plateau region to the rubbery region.

### EXAMPLES

### Example 1

The liner was removed from one side of PSA 2 and the resulting exposed pressure sensitive adhesive surface was joined at room temperature to a facestock (a 0.002 inch (0.051 mm) thick clear polyester film) using a two-roll lab laminator having a 3 lb. (1.36 kg) weight as the pressure source. Next, the second liner was removed from other side of PSA 2 and the resulting exposed pressure sensitive adhesive surface was joined at room temperature to HAA 1 using a 2-roll laminator described above to provide a label. The label comprises the following layers in order: polyester facestock/PSA/polyolefin-based heat-activated adhesive. The label was tested for Melon Bonding and the results are shown in Table 2 below.

### Example 2

The paper liner was removed from PSA 4 and the resulting exposed adhesive surface was joined at room temperature to the exposed adhesive layer of HAA 3 using a two-roll lab laminator, as described in Example 1, to provide a label. The label comprises the following layers in order: polyester facestock/PSA/polyurethane-based heat-activated adhesive/release paper. Next, the release paper was removed from the polyurethane—based adhesive layer and the label was tested for Melon Bonding as described above. The results are shown in Table 2 below.

### Example 3

A sample was prepared and evaluated as described for Example 2 with the following modification: HAA 6 was used in place of HAA 3 to provide the label. The label comprises the following layers in order: polyester facestock/PSA/polyester-based heat-activated adhesive/release paper liner. The label was tested for Melon Bonding and the results are shown in Table 2 below. The results are shown in Table 2 below.

### Comparative Example 1

A sample was prepared and evaluated as described for Example 2 with the following modifications: HAA 2 was used in place of HAA 3 to provide the label. The label comprises the following layers in order: polyester facestock/PSA/polyolefin-based heat-activated adhesive. Because there was no release paper on HAA 2, a release liner did not need to be removed prior to contacting the label with the melon. The label was tested for Melon Bonding and the results are shown in Table 2 below.

### Comparative Example 2

PSA Label 1 was applied by hand at room temperature to the melon. The label was tested for Melon Bonding and the results are shown in Table 2 below.

### Comparative Example 3

PSA 1 was coated onto the silicone release treated side of a 50 lb. (22.7 kg) paper liner and dried at 185 to 195° F. (85-91° C.) for approximately 75-80 seconds as it moved through a heated, forced air oven to provide a dried pressure sensitive adhesive thickness of approximately 0.0008 inches (0.20 mm). Next, a white polypropylene liner, having a thickness of 0.0012 inches (0.030 mm) and a silicone release treatment on one side was joined by means of its release treated side to the exposed surface of the dried pressure sensitive adhesive using a laminator as described in Example 1. The resulting double linered adhesive transfer tape was stored until further use. The construction comprised the following layers in order: paper liner/PSA/polypropylene liner. Next, the polypropylene liner was removed from the adhesive transfer tape and a 0.003 inch (0.76 mm) thick polypropylene film having an ink receptive clay coating on both sides was joined to the exposed adhesive surface using a laminator as described in Example 1 above to provide a label comprising the following layers in order: polypropylene film/PSA/paper liner. Then the paper liner was removed and the label comprising the polypropylene film with the PSA adhesive was tested for Melon Bonding. The results are shown in Table 2 below.

### Comparative Example 4

A label was prepared and evaluated as described for Example 2 with the following modification: HAA 5 was used in place of HAA 3 to provide a label. The label comprises the following layers in order: polyester facestock/PSA/polyester-based heat-activated adhesive/release paper. The release paper was removed and the label was tested for Melon Bonding and the results are shown in Table 2 below.

### Comparative Example 5

PSA 3 was coated onto the foil side of the Label Facestock and dried at 200 to 210° F. (93-99° C.) for approximately 108 seconds as it moved through a heated, forced air oven to provide a final acrylic adhesive thickness of approximately 0.0012 inches (0.030 mm). Next, HAA 7 was joined to the exposed adhesive surface of the coated foil using a laminator, as described in Example 1, to provide a label comprising the following layers in order: Label Facestock/PSA/ethylene-acrylic acid copolymer-based heat-activated adhesive. The label was tested for Melon Bonding and the results are shown in Table 2 below.

### Comparative Example 6

A label was prepared and evaluated as described for Example 2 with the following modification: HAA 4 was used in place of HAA 3 to provide a label. The label comprises the following layers in order: polyester facestock/PSA/polyamide-based heat-activated adhesive/release paper. The release paper was removed and the label was tested for Melon Bonding and the results are shown in Table 2 below.

### Comparative Example 7

Label B was used as received. Label B was tested for Melon Bonding and the results are shown in Table 2 below.

The viscosity and Tg of the heat-activated adhesives used in Examples 1-3 and Comparative Examples 1 and 4-6 was measured as described in the Viscosity Test Procedure and Glass Transition Temperature (Tg) Test Procedure above. The results are reported in Table 1 below

TABLE 1
Viscosity Results of the Heat-Activated Adhesives

| | Heat-activated | | Viscosity (Poise) | | | |
|---|---|---|---|---|---|---|
| Ex. | Adhesive | Tg (° C.) | @ 80° C. | @ 100° C. | @ 110° C. | @ 120° C. |
| Ex. 1 | polyolefin | −30 | 1.13 × 10⁵ | 3.12 × 10⁴ | 2.37 × 10⁴ | 1.87 × 10⁴ |
| Ex. 2 | polyurethane | −38 | 2.48 × 10⁵ | 1.10 × 10⁵ | 7.53 × 10⁴ | 5.49 × 10⁴ |
| Ex. 3 | polyester | −40 | 9.50 × 10⁵ | 3.76 × 10⁵ | 1.62 × 10⁵ | 4.97 × 10⁴ |
| CE 1 | polyolefin | −10 | 1.37 × 10⁷ | 4.87 × 10⁶ | 7.41 × 10⁵ | 6.77 × 10⁴ |
| CE 4 | polyester | 10 | 1.07 × 10⁷ | 5.16 × 10⁶ | 2.96 × 10⁶ | 1.20 × 10⁶ |
| CE 5 | ethylene/ | −20 | 2.24 × 10⁷ | 7.68 × 10⁶ | 1.85 × 10⁶ | 9.86 × 10⁴ |
| | acrylic acid | | | | | |
| CE 6 | polyamide | 0 | 2.80 × 10⁷ | 1.02 × 10⁷ | 1.82 × 10⁶ | 2.39 × 10⁵ |

TABLE 2
Bonding Results

| | | Bonding | | Bonding | |
|---|---|---|---|---|---|
| | Adhesive type | Results - Dry | | Results - Wet | |
| | contacting | | Fiber | | Fiber |
| Ex. | melon | Rating | Pullout | Rating | Pullout |
| Ex. 1 | Heat-activated | 7-8 | some | 5-6 | some |
| Ex. 2- trial 1 | Heat-activated | 2 | none | 1 | none |
| Ex. 2- trial 2 | Heat-activated | 7 | some | 5 | some |
| Ex. 3- trial 1 | Heat-activated | 7-8 | some | 5-6 | some |
| Ex. 3- trial 2 | Heat-activated | 8 | some | 6 | some |
| CE 1 | Heat-activated | 5-6 | some | 3-4 | none |
| CE 2 | Pressure-sensitive | 5 | minimal | 1 | none |
| CE 3 | Pressure-sensitive | 4-5 | minimal | 1 | none |
| CE 4 | Heat-activated | 3 | none | 2 | none |
| CE 5 | Heat-activated | 1 | none | 1 | none |
| CE 6 | Heat-activated | 1-2 | none | 1 | none |
| CE 7 | Heat-activated | 1 | none | 1 | none |

In Examples 2 and 3 in Table 2 above, two different trials were done. The first trial used a contact time with the hot iron of about 2 to 5 seconds, while trial 2 used a contact time of about 10-12 seconds. As shown in Table 2, Example 2 performed better with the longer contact time, while a slight increase in performance was seen for Example 3.

Although the viscosity of the heat-activated adhesive in used in Example 2 at 100° C. was 1.10×10⁵ Poise, the label did not show any fiber pull out in the Melon Bonding method described above. A Modulated Differential Scanning calorimetry (MDSC) analysis of the heat-activated adhesive in HAA 3 (the heat-activated adhesive used in Example 2) showed that this adhesive displays a significant, but relatively narrow softening range. Therefore, the Melon Bonding method was repeated using a longer contact time to soften sufficient material. As shown in Example 2—trial 2, the longer contact time resulted in improved bonding of the label with the melon. It is believed that although materials may have a similar melt viscosity, if they comprise significant crystallinity, the contact time of the heating iron may be increased to supply sufficient energy in order to soften the material relative to an adhesive comprising less crystalline content.

Foreseeable modifications and alterations of this invention will be apparent to those skilled in the art without departing from the scope and spirit of this invention. This invention should not be restricted to the embodiments that are set forth in this application for illustrative purposes.

What is claimed is:

1. An article comprising a piece of produce and a label, wherein the label comprises a facestock and a heat-activated adhesive layer having a viscosity at 100° C. of less than 4.5×10⁶ Poise as measured according to the Viscosity Test Procedure, wherein the heat-activated adhesive layer bonds the label to a surface of the piece of produce.

2. The article according to claim 1, wherein the heat-activated adhesive has a glass transition temperature of no more than −25° C.

3. The article according to claim 1, wherein the heat-activated adhesive layer comprises an adhesive polymer, wherein the adhesive polymer comprises at least one of: a polyester, a polyurethane, a polyolefin, and combinations thereof.

4. The article according to claim 1, wherein the produce has a fibrous surface.

5. The article according to claim 4, wherein the produce is a cantaloupe, a muskmelon, a honeydew, a coconut, or a kiwi.

6. The article according to claim 1, wherein the produce has an irregular surface.

7. The article according to claim 6, wherein the produce is a pineapple, an avocado, or a cucumber.

8. The article according to claim 1, wherein the produce has a pitted surface.

9. The article according to claim 8, wherein the produce is an orange, a lemon, or a lime.

10. The article according to claim 1, wherein the facestock comprises a plastic film.

11. The article according to claim 10, wherein the plastic film is a polyester.

12. The article according to claim 1, wherein the label further comprises an intermediate layer disposed between the facestock and the heat-activated adhesive.

13. The article according to claim 12, wherein the intermediate layer is selected from a pressure sensitive adhesive layer, a primer layer, or a combination thereof.

14. A method of labeling produce comprising: providing a label comprising a facestock and a heat-activated adhesive layer, and heating the heat-activated adhesive layer to bond the label to a surface of a piece of produce, wherein the heat-activated adhesive layer has a viscosity at 100° C. of less than 4.5×10⁶ Poise.

15. The method according to claim 14, further comprising removing the label.

16. The method according to claim 15 wherein the label is applied to a melon and when removed, at least one fiber from the melon remains on the heat-activated adhesive.
